(19) United States
(12) Patent Application Publication
(10) Pub. No.: US 2024/0329317 A1
(43) Pub. Date: Oct. 3, 2024

(54) MICRO-RING WAVEGUIDE HEATER

(71) Applicant: Taiwan Semiconductor Manufacturing Company, Ltd., Hsinchu (TW)

(72) Inventor: Chan-Hong Chern, Palo Alto, CA (US)

(21) Appl. No.: 18/192,704

(22) Filed: Mar. 30, 2023

(51) Int. Cl. G02B 6/293

(52) U.S. Cl. CPC G02B 6/29395; G02B 6/29338

(57) ABSTRACT

An integrated chip including a semiconductor waveguide layer over a base dielectric layer. The semiconductor waveguide layer forms a bus waveguide and a micro-ring waveguide alongside the bus waveguide. A heater is over the micro-ring waveguide. The heater includes a heater ring, a first heater contact pad, a first heater arm extending from the heater ring to the first heater contact pad, a second heater contact pad, and a second heater arm extending from the heater ring to the second heater contact pad. A first contact is coupled to the heater at the first heater contact pad. A second contact is coupled to the heater at the second heater contact pad. A width of the first heater arm increases non-linearly as a distance from the heater ring increases.

### BACKGROUND

Optical waveguides are often used as components in integrated optical circuits. Optical waveguides are used to confine and guide light from a first point on an integrated chip (IC) to a second point on the IC with minimal attenuation. Many modern optical waveguides are formed using semiconductors. A semiconductor waveguide may include an optical converter or an optical coupler for optically coupling an optical fiber to the semiconductor waveguide.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a top view of some embodiments of an integrated chip comprising a heater over a micro-ring waveguide.

FIG. 1B and FIG. 1C illustrate cross-sectional views of some embodiments of the integrated chip of FIG. 1A.

FIG. 2 illustrates a three-dimensional view of some embodiments of the integrated chip of FIGS. 1A-1C.

FIGS. 3-11 illustrate top views of some other embodiments of an integrated chip comprising a heater over a micro-ring waveguide.

FIGS. 12A-24A illustrate top views and FIGS. 12B-24B illustrate corresponding cross-sectional views of some embodiments of a method for forming an integrated chip comprising a heater over a micro-ring waveguide.

FIG. 25 illustrates a flow diagram of some embodiments of a method for forming an integrated chip comprising a heater over a micro-ring waveguide.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

A photonic integrated chip includes a semiconductor waveguide layer over a base dielectric layer. The semiconductor waveguide layer forms a bus waveguide and a micro-ring waveguide alongside the bus waveguide. In some examples, the micro-ring waveguide may form a micro-ring resonator for creating resonance in optical signals traveling within the waveguide. In some other examples, the micro-ring waveguide may form a micro-ring modulator for modulating a phase of optical signals traveling within the waveguide.

The performance of the micro-ring waveguide is sensitive to temperature variation. For example, a resonant wavelength and/or a phase shift in the micro-ring waveguide may vary based on the temperature of the micro-ring waveguide. Thus, some integrated chips include a heater over the micro-ring waveguide to improve a control of the temperature of the micro-ring waveguide. By controlling the temperature of the heater, a control the temperature of the micro-ring waveguide can be improved. By improving the control of the temperature of the micro-ring waveguide, a control of the performance (e.g., the resonant wavelength and/or phase shift) of the micro-ring waveguide can be improved.

The heater is formed by a conductive heater layer. The heater includes a heater ring, a first heater contact pad, a first heater arm extending from the heater ring to the first heater contact pad, a second heater contact pad, and a second heater arm extending form the heater ring to the second heater contact pad. The heater ring is directly over the micro-ring waveguide. The first heater arm joins the heater ring at a first location along the heater ring and the second heater arm joins the heater ring at a second location along the heater ring.

Achieving temperature uniformity along the heater ring can be challenging. In some instances, the temperature of the heater ring at the first and second locations (e.g., where the heater arms join the heater ring) may differ from the temperature of the heater ring along other portions of the heater ring due to dimensional differences between the heater arms and the heater ring. For example, if the widths of heater arms are less than a wall thickness of the heater ring (e.g., a difference between an inner radius and an outer radius of the heater ring), a temperature of the heater ring may be higher at the first and second locations than along other portions of the heater ring. Conversely, if the widths of the heater arms are greater than the width of the heater ring, the temperature of the heater ring may be lower at the first and second locations than along other portions of the heater ring. When the temperature of the heater ring is not uniform around the heater ring, the temperature of the micro-ring waveguide may not be uniform around the micro-ring waveguide. Consequently, a performance of the micro-ring waveguide may be reduced.

Further, preventing heat loss at the heater arms can be challenging. Preferably, the temperature of the heater arms is lower than the temperature of the heater ring to reduce heat loss at the heater arms. However, if the widths of the heater arms are less than or equal to the width of the heater ring, the temperature of the heater arms may be greater than or equal to the temperature of the heater ring. Consequently, heat loss may occur at the heater arms and thus an efficiency of the heater may be reduced.

In various embodiments of the present disclosure, the widths of the heater arms are tapered in non-linear manner to improve the temperature uniformity along the heater ring and reduce heat loss at the heater arms. For example, the width of the first heater arm where the first heater arm joins the heater ring is approximately equal to the wall thickness of the heater ring. Thus, the temperature of the heater ring where the first heater arm joins the heater ring may have improved uniformity with the temperature of other portions of the heater ring. Further, the width of the first heater arm increases non-linearly as a distance from the heater ring increases so that the width of the first heater arm increases gradually near the heater ring and more rapidly as the distance from the heater ring increases. Because the width of the heater arm increases gradually near the heater ring, the temperature of the first heater arm decreases gradually near the heater ring. Thus, the uniformity of the temperature of the heater ring may be further improved. Further, because the width of the heater arm increases more rapidly as the distance from the heater ring increases, the temperature of the first heater arm decreases more rapidly further from the heater ring. Thus, heat loss at the first heater arm may be reduced.

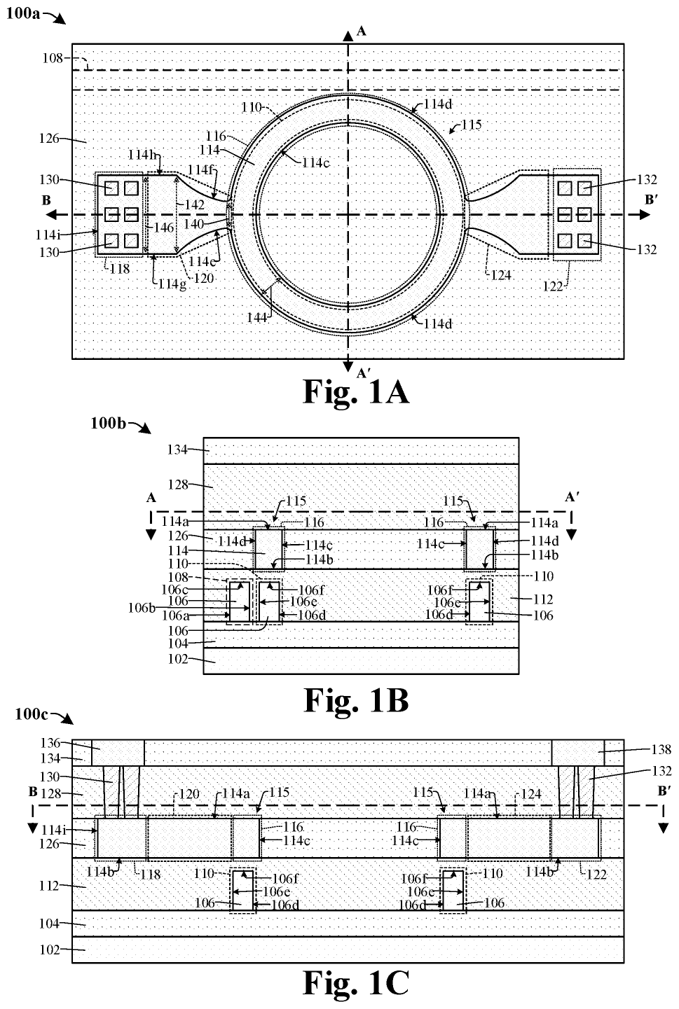

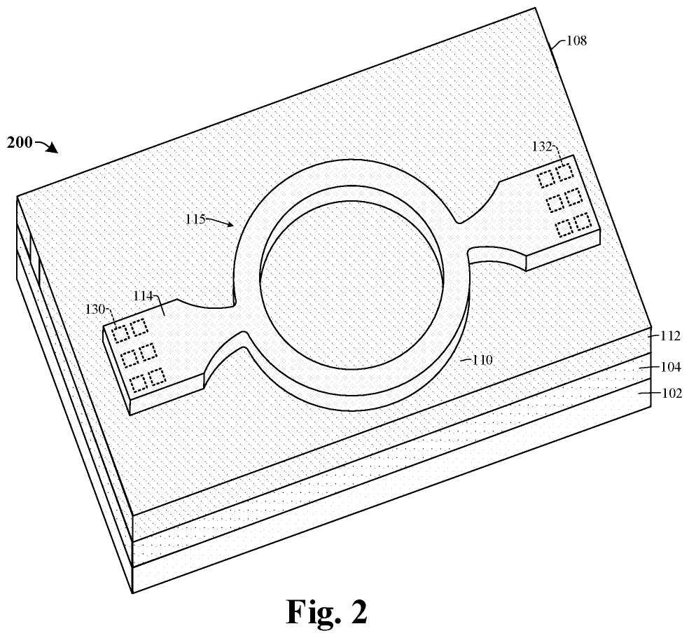

FIG. 1A illustrates a top view 100a of some embodiments of an integrated chip comprising a heater 115 over a micro-ring waveguide 110. FIG. 1B illustrates a first cross-sectional view 100b of some embodiments of the integrated chip of FIG. 1A. FIG. 1C illustrates a second cross-sectional view 100c of some embodiments of the integrated chip of FIG. 1A. In some embodiments, cross-sectional view 100b of FIG. 1B may be taken across line A-A′ of FIG. 1A and cross-sectional view 100c of FIG. 1C may be taken across line B-B′ of FIG. 1A. FIG. 2 illustrates a three-dimensional view 200 of some embodiments of the integrated chip of FIGS. 1A-1C.

Referring to FIGS. 1A, 1B, 1C, and 2, a base dielectric layer 104 is over a semiconductor substrate 102. A semiconductor waveguide layer 106 is over the base dielectric layer 104. The semiconductor waveguide layer 106 forms a bus waveguide 108 and the micro-ring waveguide 110 alongside the bus waveguide 108. For example, a pair of first sidewalls 106a, 106b and a first upper surface 106c of the semiconductor waveguide layer 106 form (e.g., delimit) the bus waveguide 108. Further, an inner sidewall 106d, an outer sidewall 106e, and a second upper surface 106f of the semiconductor waveguide layer 106 form (e.g., delimit) the micro-ring waveguide 110. In some embodiments, the micro-ring waveguide 110 may form a micro-ring resonator for creating resonance in optical signals traveling within the waveguide. In some other embodiments, the micro-ring waveguide 110 may form a micro-ring modulator for modulating a phase of optical signals traveling within the waveguide. A cladding layer 112 is over the semiconductor waveguide layer 106.

A conductive heater layer 114 and a first upper dielectric layer 126 are over the semiconductor waveguide layer 106. The conductive heater layer 114 forms the heater 115 over the micro-ring waveguide 110. The heater 115 includes a heater ring 116, a first heater contact pad 118, and a first heater arm 120. The first heater arm 120 extends from the heater ring 116 to the first heater contact pad 118. The heater 115 further includes a second heater contact pad 122 and a second heater arm 124. The second heater arm 124 extends from the heater ring 116 to the second heater contact pad 122.

The heater ring 116 is formed (e.g., delimited) by a top surface 114a, a bottom surface 114b, an inner ring sidewall 114c, and outer ring sidewalls 114d of the conductive heater layer 114. The first heater arm 120 is formed (e.g., delimited) by the top surface 114a, the bottom surface 114b, a pair of first sidewalls 114c, 114f, and a pair of second sidewalls 114g. 114h of the conductive heater layer 114. The first sidewalls 114e, 114f extend along non-linear paths respectively from the outer ring sidewalls 114d to the second sidewalls 114g, 114h. The non-linear paths may, for example, be or follow parabolic paths or some other suitable non-linear paths. The second sidewalls 114g. 114h extend along linear paths. The second heater arm 124 is formed by similar features (e.g., the top surface 114a, the bottom surface 114b, first sidewalls which extend along non-linear paths, and second sidewalls which extend along linear paths). In some embodiments, the first heater contact pad 118 is formed (e.g., delimited) by the top surface 114a, the bottom surface 114b, the second sidewalls 114g, 114h, and a third sidewall 114i of the conductive heater layer 114. The second heater contact pad 122 is formed by similar features (e.g., the top surface 114a, the bottom surface 114b, second sidewalls, and a third sidewall).

A second upper dielectric layer 128 is over the conductive heater layer 114. A plurality of first contacts 130 extend through the second upper dielectric layer 128 and are coupled to the heater 115 at the first heater contact pad 118. A plurality of second contacts 132 extend through the second upper dielectric layer 128 and are coupled to the heater 115 at the second heater contact pad 122. In some embodiments, a third upper dielectric layer 134 is over the second upper dielectric layer 128. A first metal line 136 is over and coupled to the first contacts 130. A second metal line 138 is over and coupled to the second contacts 132.

The contacts 130, 132 can be coupled to a voltage supply. By applying voltage across the contacts 130, 132, a current is generated in the conductive heater layer 114 which causes a temperature of the conductive heater layer 114 to increase. By controlling the current in the conductive heater layer 114, the temperature of the heater 115 can be controlled.

The width of the first heater arm 120 (e.g., a distance between the pair of first sidewalls 114c, 114f) is equal to a first value (e.g., first width 140) at a first location where the first heater arm 120 joins the heater ring 116 (e.g., where the first sidewalls 114c, 114f meet the outer ring sidewalls 114d). Further, the width of the first heater arm 120 is equal to a second value (e.g., second width 142), greater than the first value, at a second location where the first sidewalls 114c, 114f meet the second sidewalls 114g. 114g, respectively. A wall thickness 144 of the heater ring 116 is measured as a difference between an outer radius of the heater ring 116 and an inner radius of the heater ring 116 (e.g., the distance between the inner ring sidewall 114c and the outer ring sidewall 114d). Further, the wall thickness 144 of the heater ring 116 is equal to a third value.

A difference between the first value (e.g., first width 140) and the third value (e.g., wall thickness 144) is substantially small. For example, the difference is less than 10%, less than 5%, or some other suitable value. Because the difference is substantially small, the temperature of the heater ring 116 at the first location (e.g., where the first heater arm 120 joins the heater ring 116) may have improved uniformity with the temperature of the heater ring 116 along other portions of the heater ring 116. In some instances, if the difference is too large, the temperature of the heater ring 116 where the first heater arm 120 joins the heater ring 116 may have reduced uniformity with the temperature of the heater ring 116 along other portions of the heater ring 116.

In addition, the width of the first heater arm 120 increases non-linearly as a distance from the heater ring 116 increases. More specifically, the width of the first heater arm 120 (e.g., the distance between the pair of first sidewalls 114c, 114f) increases non-linearly from the first value (e.g., first width 140) at the first location to the second value (e.g., second width 142) at the second location. The rate at which is the width of the first heater arm 120 increases (e.g., the rate of change of the width of the first heater arm 120) is lower at the first location and higher at the second location so that the width of the first heater arm 120 increases more gradually near the heater ring 116 and then more rapidly further from the heater ring 116.

Because the width of the first heater arm 120 increases gradually near the heater ring 116, the temperature of the first heater arm 120 decreases gradually near heater ring 116 which may further improve the uniformity of the temperature of the heater ring 116 at the first location with the temperature at other portions of the heater ring 116. Further, because the width of the first heater arm 120 increases more rapidly as the distance from the heater ring 116 increases, the temperature of the first heater arm 120 decreases more rapidly further from the heater ring 116. Thus, heat loss at the first heater arm 120 may be reduced.

In some embodiments, the rate of change of the width of the first heater arm 120 increases as the distance from the heater ring 116 increases. In some instances, if the width of the conductive heater layer 114 increases too rapidly near the heater ring 116, the temperature of the heater ring 116 where the first heater arm 120 joins the heater ring 116 may have reduced uniformity with the temperature of the heater ring 116 along other portions of the heater ring 116. Further, if the width of the conductive heater layer 114 increases too gradually further from the heater ring 116, heat loss may at the first heater arm 120.

In some embodiments, the width of the first heater arm 120 at the second location (e.g., second width 142) is substantially greater than the first width of the first heater arm 120 at the first location (e.g., first width 140). For example, the width at the second location (e.g., second width 142) is at least 40% greater than the width at the first location (e.g., first width 140), at least 50% greater than the width at the first location, or some other suitable value. If the width at the second location is not substantially greater than the width at the first location, heat loss may occur along the portions of the first heater arm 120 that are spaced from the heater ring 116 (e.g., at the second location).

In some embodiments, the width of the first heater arm 120 is approximately constant (e.g., deviates less than 10%, less than 5%, or some other suitable value) from the second location to a third location where the first heater arm 120 joins the first heater contact pad 118. In other words, a distance between the pair of second sidewalls 114g. 114h is equal to the second value (e.g., second width 142) at the second location, the distance between the pair of second sidewalls 114g, 114h is equal to a third value (e.g., third width 146) at the third location where the first heater arm 120 joins the first heater contact pad 118, and the third value is approximately equal to the second value (e.g., a difference between the third value and the second value is less than 10%, less than 5%, or some other suitable value).

Although the heater arms 120, 124 are shown extending parallel to bus waveguide 108 in FIG. 1A, it will be appreciated that in some embodiments, the heater arms 120, 124 may alternatively extend perpendicular to the bus waveguide 108. The first upper dielectric layer 126, the second upper dielectric layer 128, the contacts 130, 132, the third upper dielectric layer 134, and the metal lines 136, 138 are not shown in FIG. 2 for clarity of illustration. Further, the cladding layer 112 is shown as partially transparent in FIG. 2 for clarity of illustration.

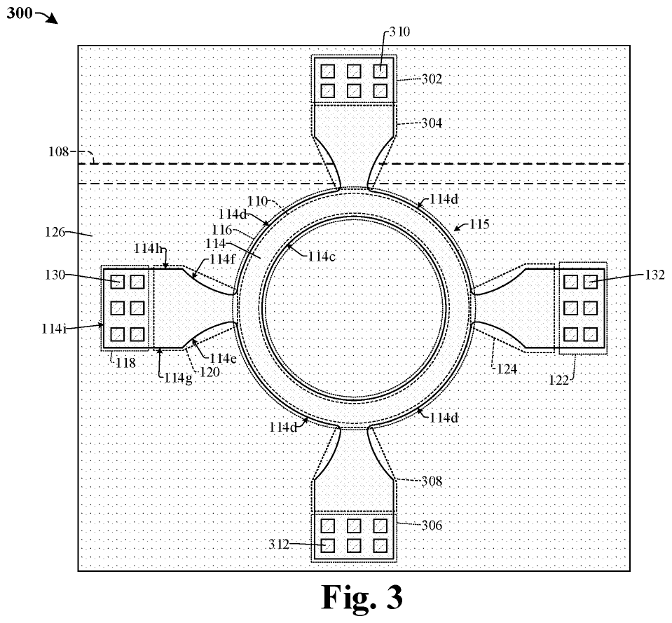

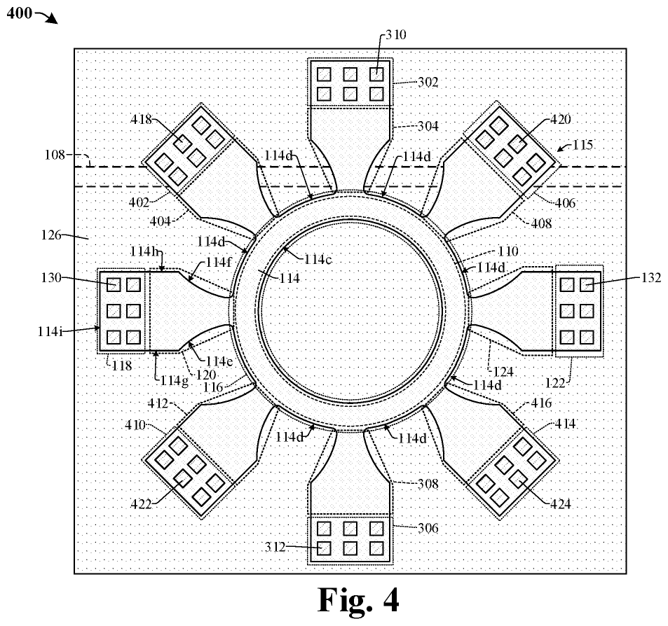

FIG. 3 and FIG. 4 illustrate top view 300 and top view 400, respectively, of some embodiments of the integrated chip of FIG. 1A in which greater than two heater arms extend outward from the heater ring 116.

In some embodiments (e.g., as illustrated in FIG. 3), the heater 115 includes four heater arms that extend outward from the heater ring 116. For example, the heater 115 includes a third heater contact pad 302 and a third heater arm 304, the third heater arm 304 extending from the heater ring 116 to the third heater contact pad 302. The heater 115 further includes a fourth heater contact pad 306 and a fourth heater arm 308, the fourth heater arm 308 extending from the heater ring 116 to the fourth heater contact pad 306. A plurality of third contacts 310 are over and coupled to the third heater contact pad 302 and a plurality of fourth contacts 312 are over and coupled to the fourth heater contact pad 306.

In some other embodiments (e.g., as illustrated in FIG. 4), the heater 115 includes eight heater arms that extend outward from the heater ring 116. For example, the heater 115 includes a fifth heater contact pad 402, a sixth heater contact pad 406, a seventh heater contact pad 410, and an eighth heater contact pad 414. The heater 115 further includes a fifth heater arm 404 extending from the heater ring 116 to the fifth heater contact pad 402, a sixth heater arm 408 extending from the heater ring 116 to the sixth heater contact pad 406, a seventh heater arm 412 extending from the heater ring 116 to the seventh heater contact pad 410, and an eighth heater arm 416 extending from the heater ring 116 to the eighth heater contact pad 414. Corresponding sets of contacts 418, 420, 422, 424 are over and coupled to the heater contact pads 402, 406, 410, 414, respectively. Some other number of heater arms and heater contact pads is also possible.

The contacts 130, 132, 310, 312 are coupled to a voltage supply so that a current can be generated in the conductive heater layer 114. For example, in some embodiments, contacts 130, 132 are coupled to a positive terminal of a voltage supply and contacts 310, 312 are coupled to a negative terminal of the voltage supply. In some other embodiments, contacts 130, 132, 310, 312 are coupled to a positive terminal of a voltage supply and contacts 418, 420, 422, 424 are coupled to a negative terminal of the voltage supply.

By increasing number of heater arms and heater contact pads around the heater ring 116, the magnitude of the voltage required to heat the conductive heater layer 114 may be reduced. Thus, an efficiency of the heater 115 may be improved. Further, by increasing number of heater arms and heater contact pads around the heater ring 116, a temperature uniformity around the heater ring 116 may be further improved.

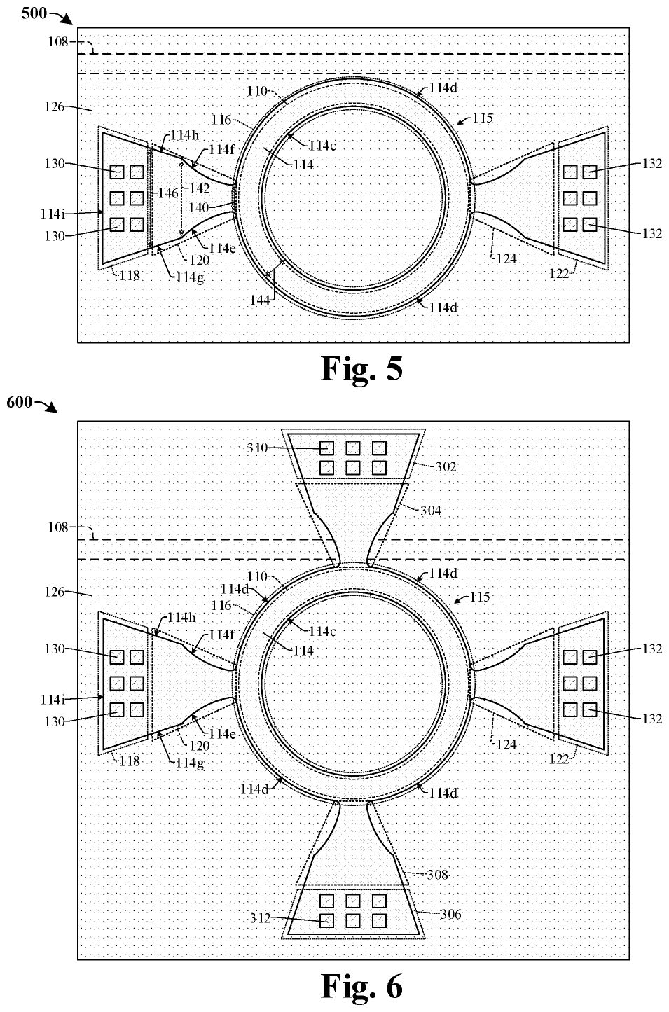

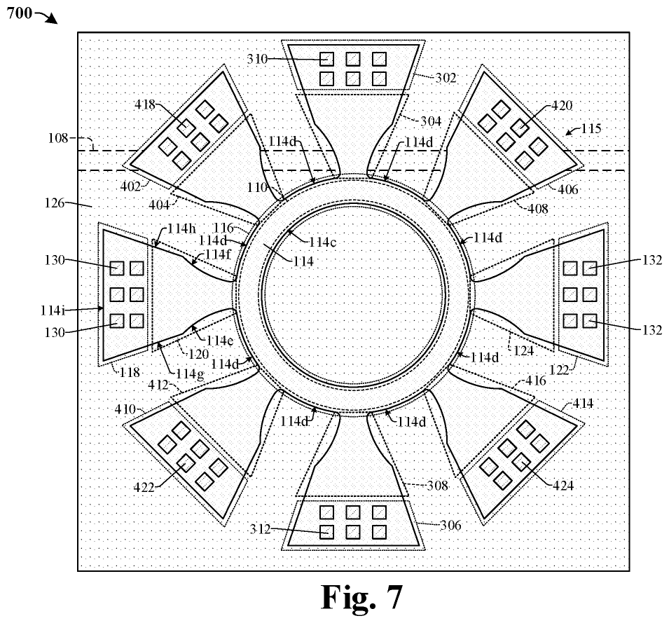

FIG. 5, FIG. 6, and FIG. 7 illustrate top view 500, top view 600, and top view 700, respectively, of some embodiments of the integrated chip of FIG. 1A in which the heater arms have a linearly tapered region following the non-linearly tapered region.

The width of the first heater arm 120 increases linearly from the second location (e.g., where the first sidewalls 114c, 114f meet the second sidewalls 114g, 114g, respectively) to the third location (e.g., where the first heater arm 120 joins the first heater contact pad 118). For example, a distance between the pair of second sidewalls 114g, 114h is equal to the second value at the second location (e.g., second width 142), the distance between the pair of second sidewalls 114g, 114h is equal to a third value, greater than the second value, at the third location (e.g., third width 146), and the distance between the pair of second sidewalls 114g, 114h increases linearly from the second value at the second location (e.g., second width 142) to the third value at the third location (e.g., third width 146). In some embodiments, the width of the first heater arm 120 further increases linearly from the third location to the third sidewall 114i.

Because the distance between the second sidewalls 114g. 114h increases linearly as the distance from the heater ring 116 increases, the temperature of the first heater arm 120 further decreases as the distance from the heater ring 116 increases. Thus, heat loss along the first heater arm 120 may be further reduced.

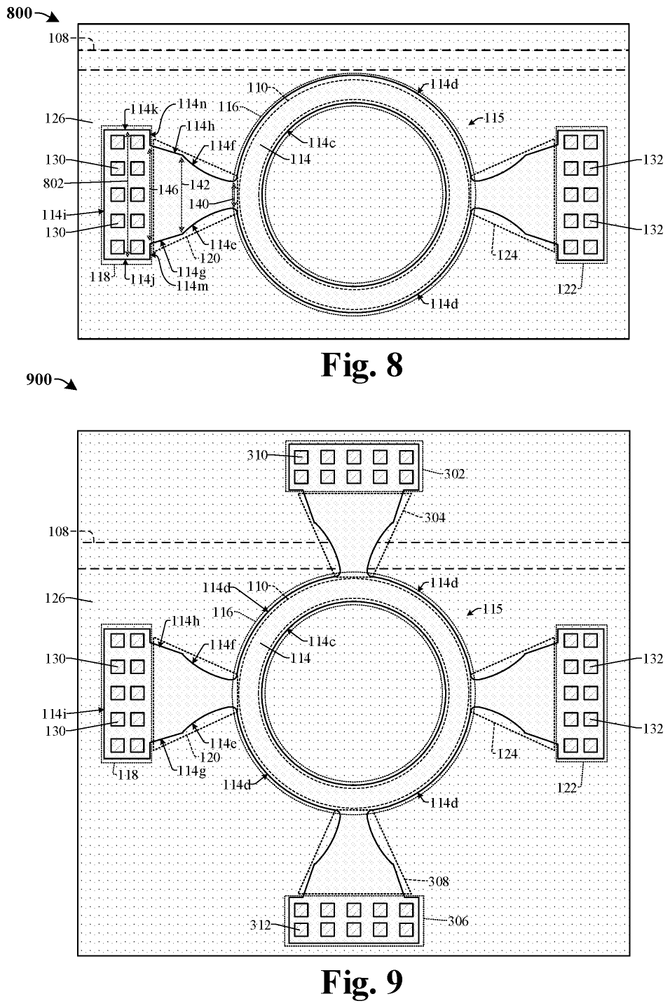

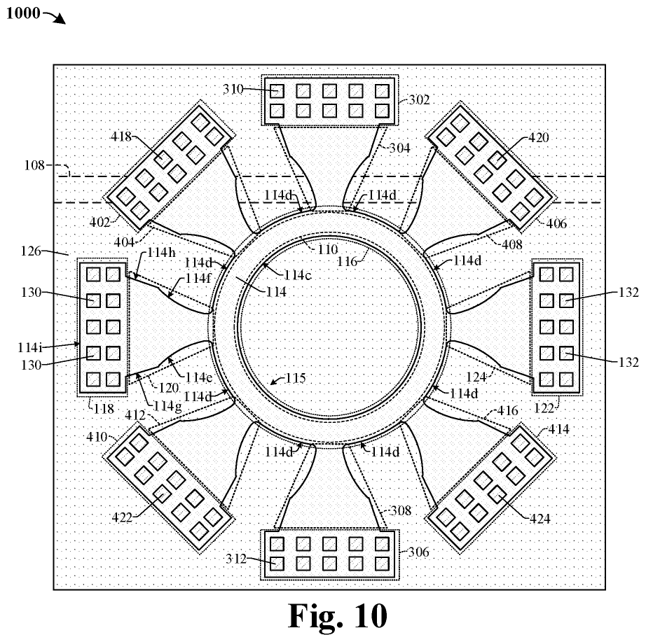

FIG. 8, FIG. 9, and FIG. 10 illustrate top view 800, top view 900, and top view 1000, respectively, of some embodiments of the integrated chip of FIG. 1A in which the heater contact pads are enlarged.

The first heater contact pad 118 is formed by the top surface 114a, the bottom surface 114b, the third sidewall 114i, a pair of fourth sidewalls 114j, 114k, and a pair of fifth sidewalls 114m, 114n. In some embodiments, the heater contact pads may be referred to as having rectangular shapes. The width of the first heater contact pad 118 (e.g., the distance between fourth sidewalls 114j. 114k) is equal to a fourth value (e.g., fourth width 802), greater than the third value (e.g., third width 146). In some embodiments, the width of the first heater contact pad 118 (e.g., fourth width 802) is greater than a maximum width of the first heater arm 120 (e.g., the maximum distance between the second sidewalls 114g, 114h).

By increasing the size of the heater contact pads, the number of contacts which can be formed over and coupled to the heater contact pads can be increased. By increasing the number of contacts at the heater contact pads, a reliability (e.g., an electromigration durability) of the contacts may be improved.

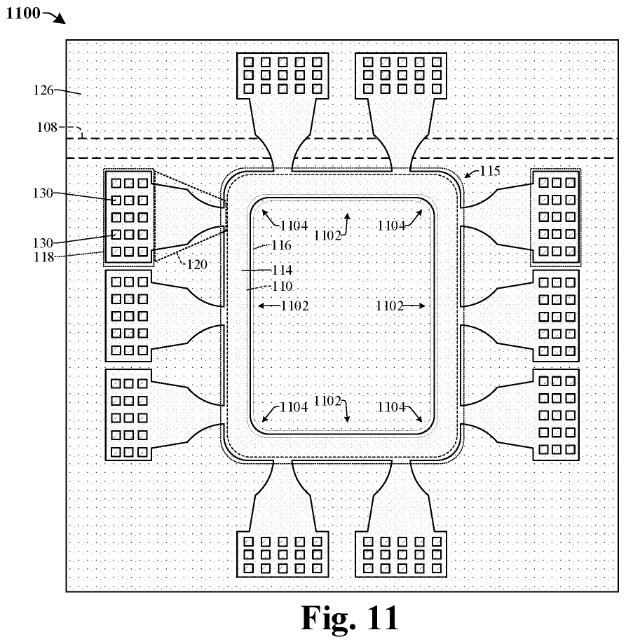

FIG. 11 illustrates top view 1100 of some embodiments of the integrated chip of FIG. 1A in which the micro-ring waveguide 110 and the heater ring 116 have rectangular ring shapes.

The micro-ring waveguide 110 and the heater ring 116 of the conductive heater layer 114 have straight (e.g., linear) segments 1102 that are connected at bend segments 1104. The rectangular shaped micro-ring waveguide 110 can have reduced light loss. For example, a light loss along micro-ring waveguide 110 can be reduced along the straight segments 1102 of the micro-ring waveguide 110 because of the linear shape of the waveguide along these segments. However, the data rate in rectangular shaped micro-ring waveguides can be reduced. Further, the space requirement for rectangular shaped micro-ring waveguides may be reduced. Thus, the rectangular shaped micro-ring waveguide 110 and the rectangular shaped heater ring 116 can be useful in larger devices with reduced data rate requirements to reduce light loss in those devices.

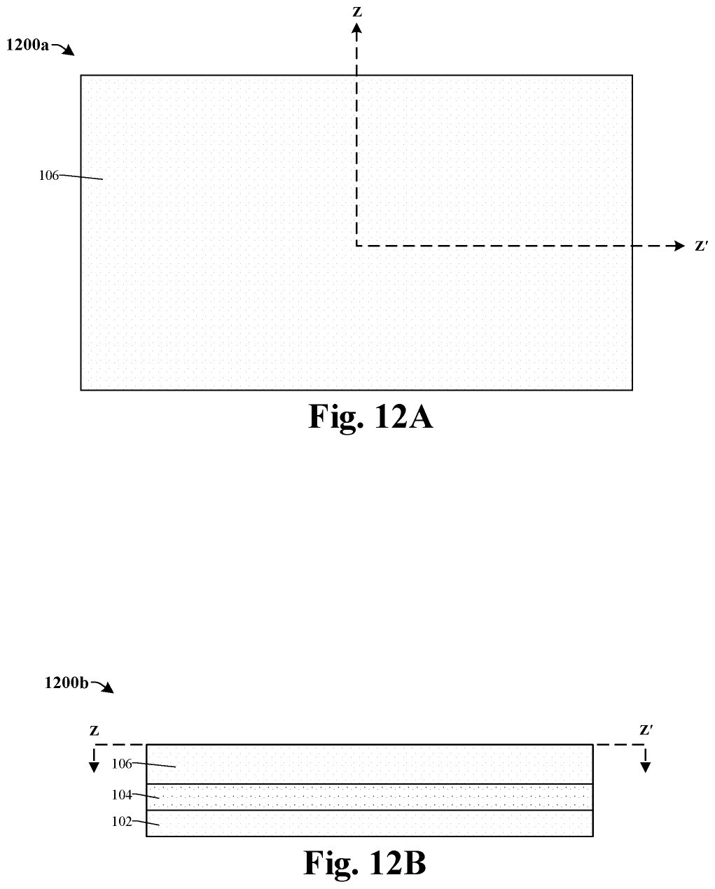

FIGS. 12A, 13A, 14A, 15A, 16A, 17A, 18A, 19A, 20A, 21A, 22A, 23A, 24A illustrate top views 1200a, 1300a, 1400a, 1500a, 1600a, 1700a, 1800a, 1900a, 2000a, 2100a, 2200a, 2300a, 2400a, respectively, and FIGS. 12B, 13B, 14B, 15B, 16B, 17B, 18B, 19B, 20B, 21B, 22B, 23B, 24B illustrate corresponding cross-sectional views 1200b, 1300b, 1400b, 1500b, 1600b, 1700b, 1800b, 1900b, 2000b, 2100b, 2200b, 2300b, 2400b, respectively, of some embodiments of a method for forming an integrated chip comprising a heater 115 over a micro-ring waveguide 110. Although FIGS. 12A, 12B through FIGS. 24A, 24B are described in relation to a method, it will be appreciated that the structures disclosed in FIGS. 12A, 12B through FIGS. 24A, 24B are not limited to such a method, but instead may stand alone as structures independent of the method.

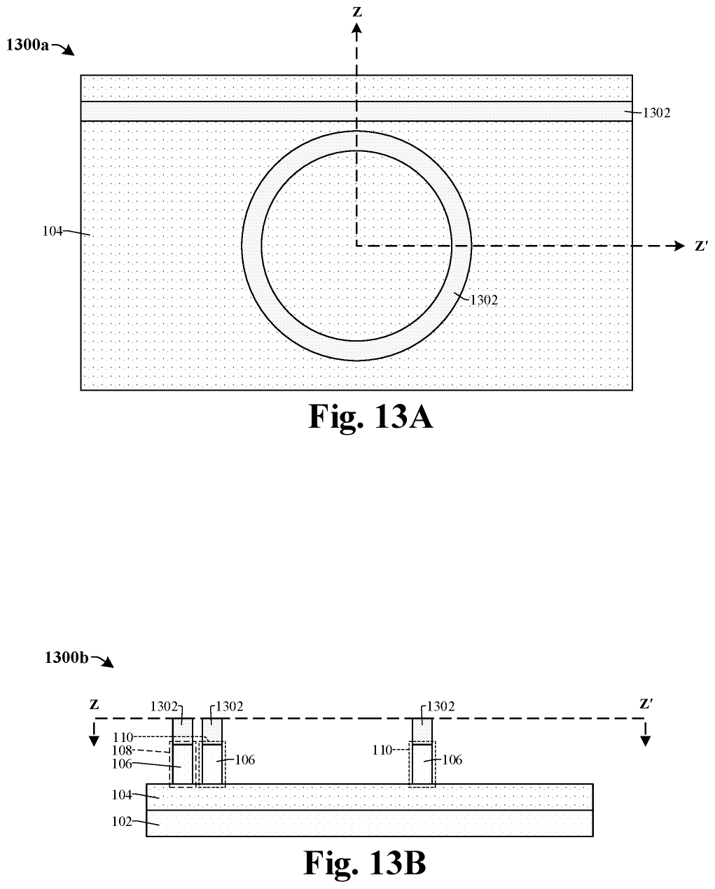

In some embodiments, cross-sectional views 1200b, 1300b, 1400b, 1500b, 1600b, 1700b, 1800b, 1900b, 2000b, 2100b, 2200b, 2300b, 2400b may be taken across lines Z-Z′ of FIGS. 12A, 13A, 14A, 15A, 16A, 17A, 18A, 19A, 20A, 21A, 22A, 23A, 24A, respectively. For example, cross-sectional view 1200b may be taken across line Z-Z′ of FIG. 12A, cross-sectional view 1300b may be taken across line Z-Z′ of FIG. 13A, and so on.

As shown in top view 1200a of FIG. 12A and corresponding cross-sectional view 1200b of FIG. 12B, a structure including a substrate 102, a base dielectric layer 104 over the substrate 102, and a semiconductor waveguide layer 106 over the base dielectric layer 104 is provided. In some embodiments, the structure is or includes a semiconductor-on-insulator (SOI) substrate or the like. In some embodiments, the semiconductor waveguide layer 106 and the substrate 102 comprise silicon or some other suitable material. In some embodiments, the base dielectric layer 104 comprises silicon dioxide or some other suitable material.

As shown in top view 1300a of FIG. 13A and corresponding cross-sectional view 1300b of FIG. 13B, the semiconductor waveguide layer 106 is patterned to form (e.g., delimit) a bus waveguide 108 and a micro-ring waveguide 110 from the semiconductor waveguide layer 106. In some embodiments, the patterning comprises forming a masking layer 1302 over the semiconductor waveguide layer 106 and etching the semiconductor waveguide layer 106 according to the masking layer 1302. In some embodiments, the etching comprises a dry etching process such as, for example, a plasma etching process, a reactive ion etching process, an ion beam etching process, or some other suitable process. In some embodiments, the masking layer 1302 comprises a photoresist mask layer, a hard mask layer, or some other suitable masking layer. In some embodiments, the masking layer 1302 is removed during and/or after the etching.

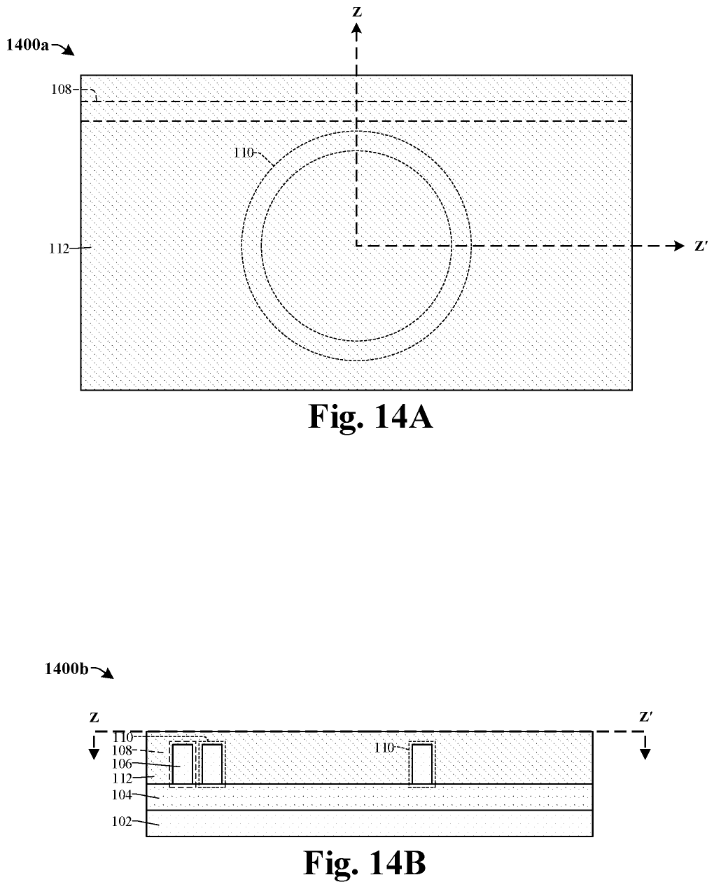

As shown in top view 1400a of FIG. 14A and corresponding cross-sectional view 1400b of FIG. 14B, a cladding layer 112 is deposited over and along sidewalls of the semiconductor waveguide layer 106. In some embodiments, the cladding layer 112 comprises silicon dioxide or some other suitable material. In some embodiments, the cladding layer 112 is deposited by a chemical vapor depositor (CVD) process, a physical vapor deposition (PVD) process, an atomic layer deposition (ALD) process, or some other suitable process.

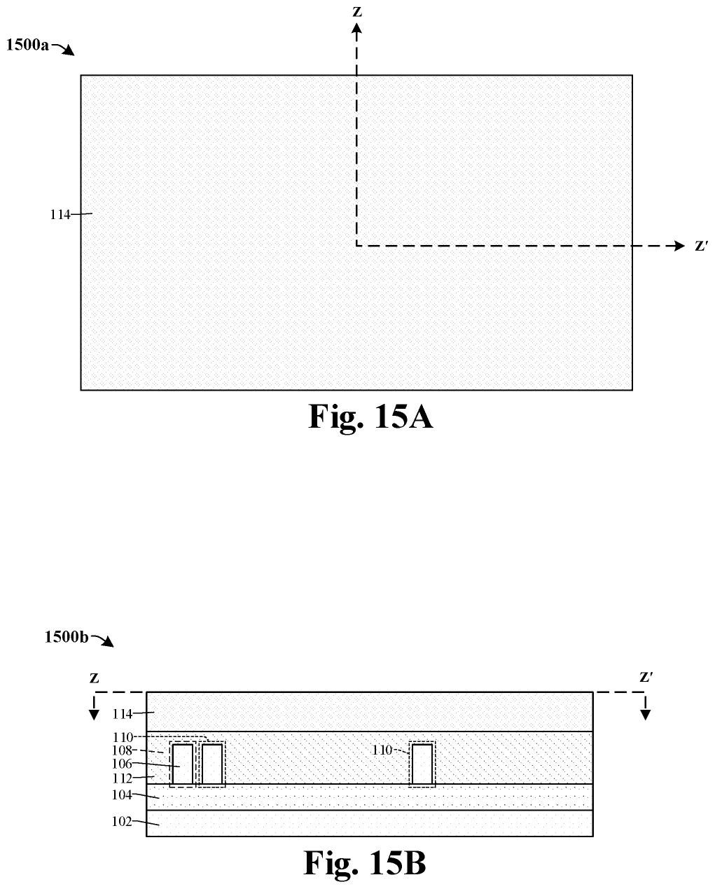

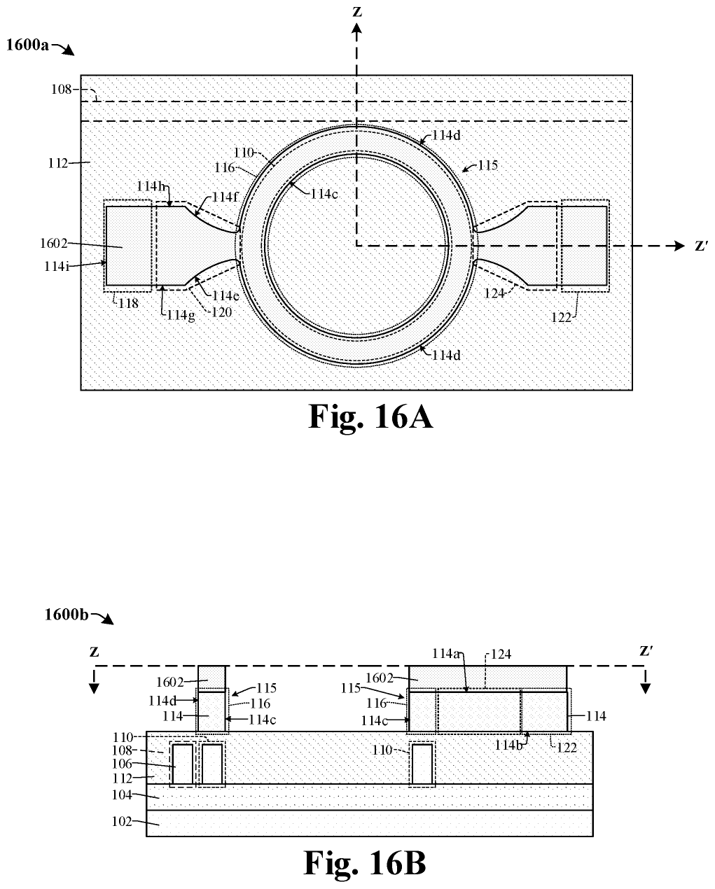

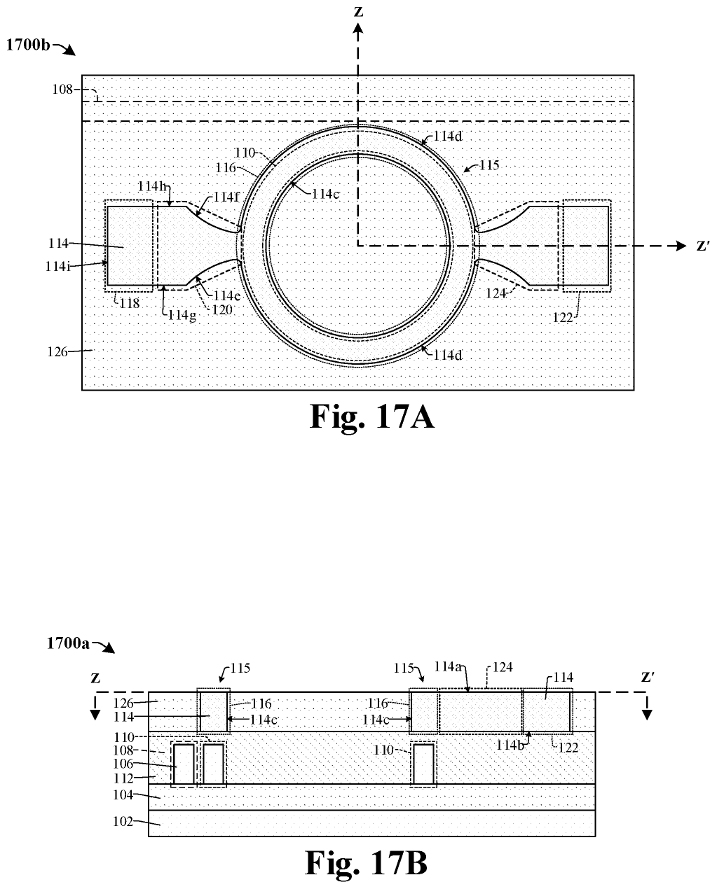

FIGS. 15A, 16A, 17A illustrate top views 1500a, 1600a, 1700a, respectively, and FIGS. 15B, 16B, 17B illustrate corresponding cross-sectional views 1500b, 1600b, 1700b, respectively, of some embodiments of one method for forming a heater 115 over the micro-ring waveguide 110.

As shown in top view 1500a of FIG. 15A and corresponding cross-sectional view 1500b of FIG. 15B, a conductive heater layer 114 is deposited over the cladding layer 112. In some embodiments, the conductive heater layer 114 comprises tungsten, titanium nitride, or some other suitable material. In some embodiments, the conductive heater layer 114 is deposited by a CVD process, a PVD process, an ALD process, or some other suitable process.

As shown in top view 1600a of FIG. 16A and corresponding cross-sectional view 1600b of FIG. 16B, the conductive heater layer 114 is patterned to form (e.g., delimit) a heater 115 including a heater ring 116, heater contact pads 118, 122, and heater arms 120, 124. In some embodiments, the patterning comprises forming a masking layer 1602 over the conductive heater layer 114 and etching the conductive heater layer 114 according to the masking layer 1602. In some embodiments, the etching comprises a dry etching process or some other suitable process. In some embodiments, the masking layer 1602 comprises a photoresist mask layer, a hard mask layer, or some other suitable masking layer.

In some embodiments, the number of heater arms and heater contact pads that are formed around the heater ring 116 can vary (e.g., as illustrated in FIGS. 1A, 3, 4). In some embodiments, the heater arms are formed to have linearly tapered regions (e.g., as illustrated in FIGS. 5-7). In some embodiments, the heater contact pads are formed to be wider than the heater arms (e.g., as illustrated in FIGS. 8-10).

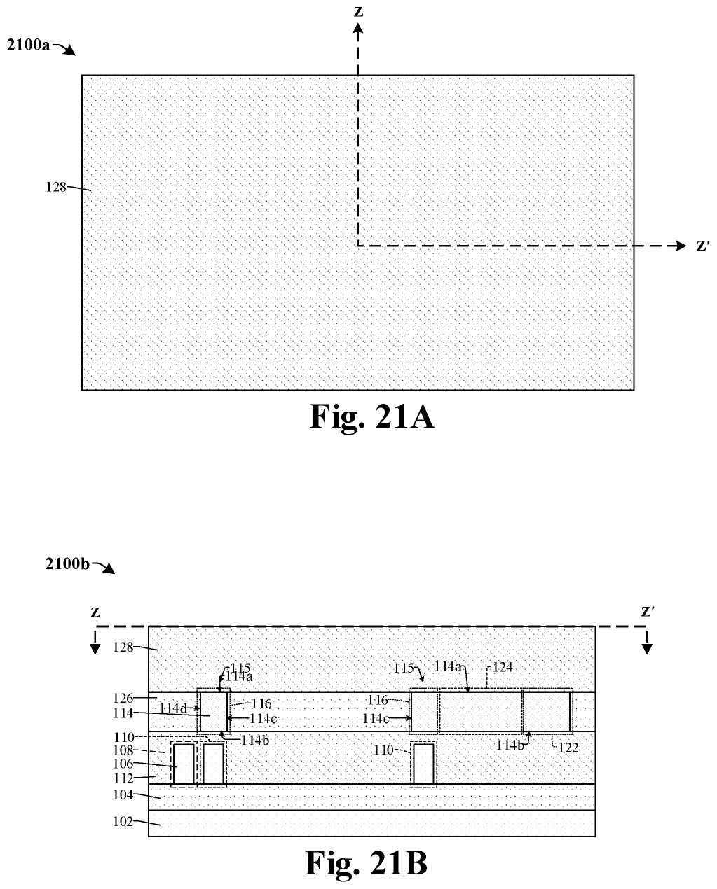

As shown in top view 1700a of FIG. 17A and corresponding cross-sectional view 1700b of FIG. 17B, a first upper dielectric layer 126 is deposited over the heater 115 and along sidewalls of the heater 115. In some embodiments, the first upper dielectric layer 126 comprises silicon dioxide, silicon nitride, or some other suitable material. In some embodiments, the first upper dielectric layer 126 is deposited by a CVD process, a PVD process, an ALD process, or some other suitable process. In some embodiments, a planarization process (e.g., a chemical mechanical planarization (CMP) or some other suitable process) is performed on the first upper dielectric layer 126 and the conductive heater layer 114 after the first upper dielectric layer 126 is deposited. In some embodiments, the method continues at FIGS. 21A, 21B.

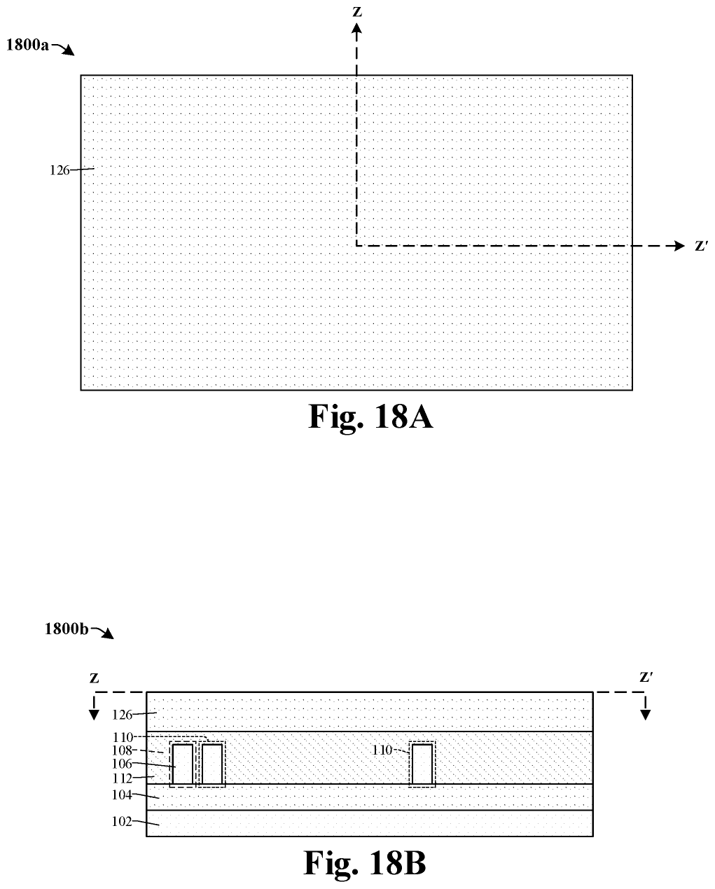

FIGS. 18A, 19A, 20A illustrate top views 1800a, 1900a, 2000a, respectively, and FIGS. 18B, 19B, 20B illustrate corresponding cross-sectional views 1800b, 1900b, 2000b, respectively, of some embodiments of an alternative method for forming the heater 115 over the micro-ring waveguide 110.

As shown in top view 1800a of FIG. 18A and corresponding cross-sectional view 1800b of FIG. 18B, a first upper dielectric layer 126 is deposited over the cladding layer 112. In some embodiments, the first upper dielectric layer 126 comprises silicon dioxide, silicon nitride, or some other suitable material. In some embodiments, the first upper dielectric layer 126 is deposited by a CVD process, a PVD process, an ALD process, or some other suitable process.

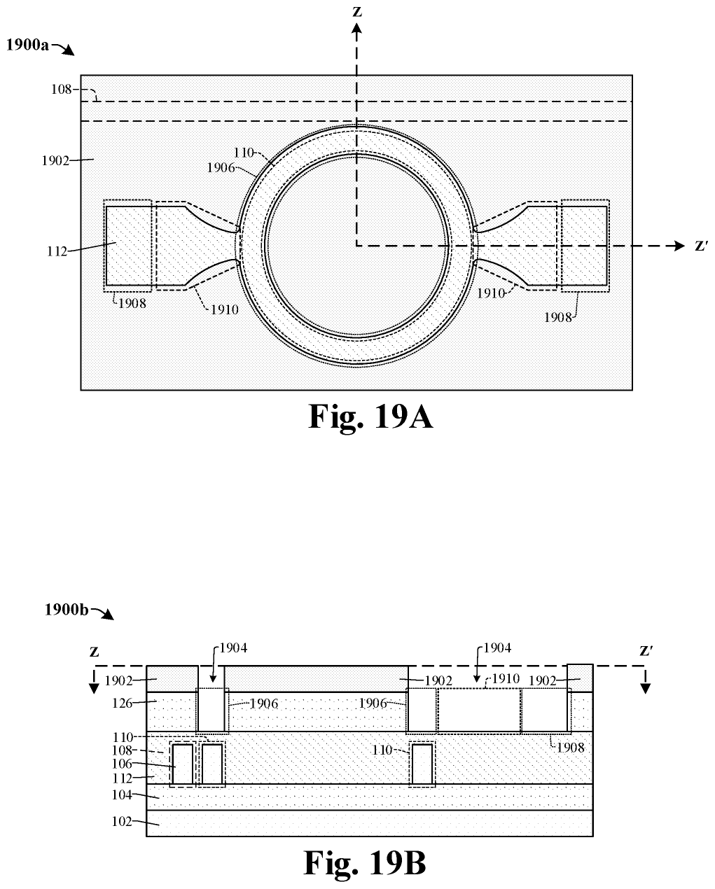

As shown in top view 1900a of FIG. 19A and corresponding cross-sectional view 1900b of FIG. 19B, the first upper dielectric layer 126 is patterned to form a heater opening 1904 in the first upper dielectric layer 126. The heater opening 1904 includes a heater ring region 1906, heater contact pad regions 1908, and heater arm regions 1910. In some embodiments, the patterning comprises forming a masking layer 1902 over the first upper dielectric layer 126 and etching the first upper dielectric layer 126 according to the masking layer 1902. In some embodiments, the etching comprises a dry etching process or some other suitable process. In some embodiments, the masking layer 1902 comprises a photoresist mask layer, a hard mask layer, or some other suitable masking layer.

In some embodiments, the number of heater arm openings and heater contact pad openings that are formed around the heater ring region 1906 of the heater opening 1904 can vary. In some embodiments, the heater arm openings are formed to have linearly tapered regions. In some embodiments, the heater contact pad openings are formed to be wider than the heater arm openings.

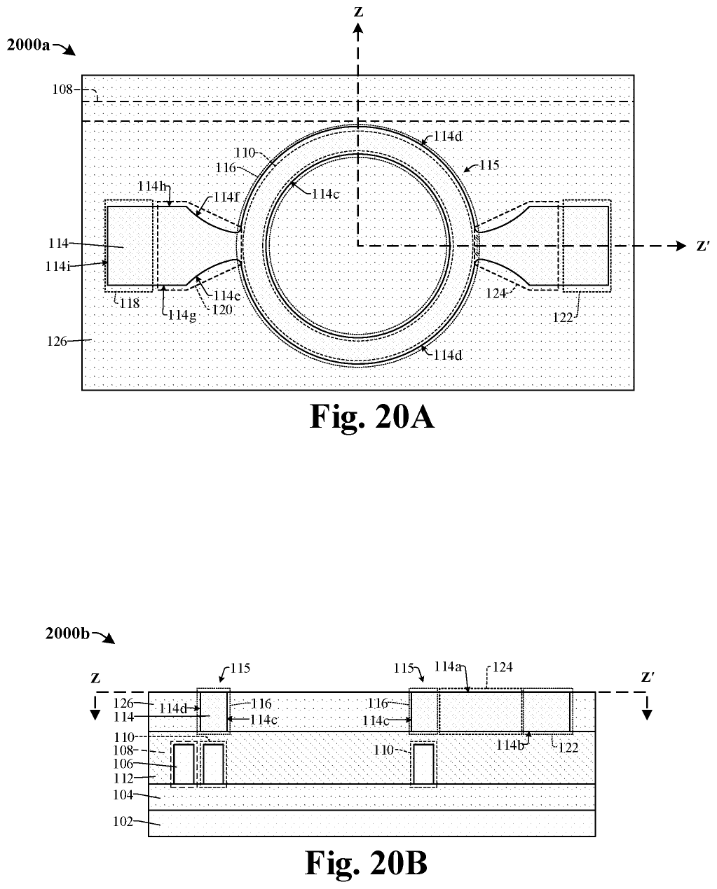

As shown in top view 2000a of FIG. 20A and corresponding cross-sectional view 2000b of FIG. 20B, a conductive heater layer 114 is deposited over the first upper dielectric layer 126 and in the heater opening 1904 to form the heater 115. In some embodiments, the conductive heater layer 114 comprises tungsten, titanium nitride, or some other suitable material. In some embodiments, the conductive heater layer 114 is deposited by a CVD process, a PVD process, an ALD process, or some other suitable process.

In some embodiments, a planarization process (e.g., a CMP or some other suitable planarization process) is performed on the conductive heater layer 114 and the first upper dielectric layer 126 after the conductive heater layer 114 is deposited. The planarization removes the conductive heater layer 114 from over the first upper dielectric layer 126 and further defines the heater 115.

As shown in top view 2100a of FIG. 21A and corresponding cross-sectional view 2100b of FIG. 21B, a second upper dielectric layer 128 is deposited over the conductive heater layer 114 and the first upper dielectric layer 126. In some embodiments, the second upper dielectric layer 128 comprises silicon dioxide, silicon nitride, or some other suitable material. In some embodiments, the second upper dielectric layer 128 is deposited by a CVD process, a PVD process, an ALD process, or some other suitable process.

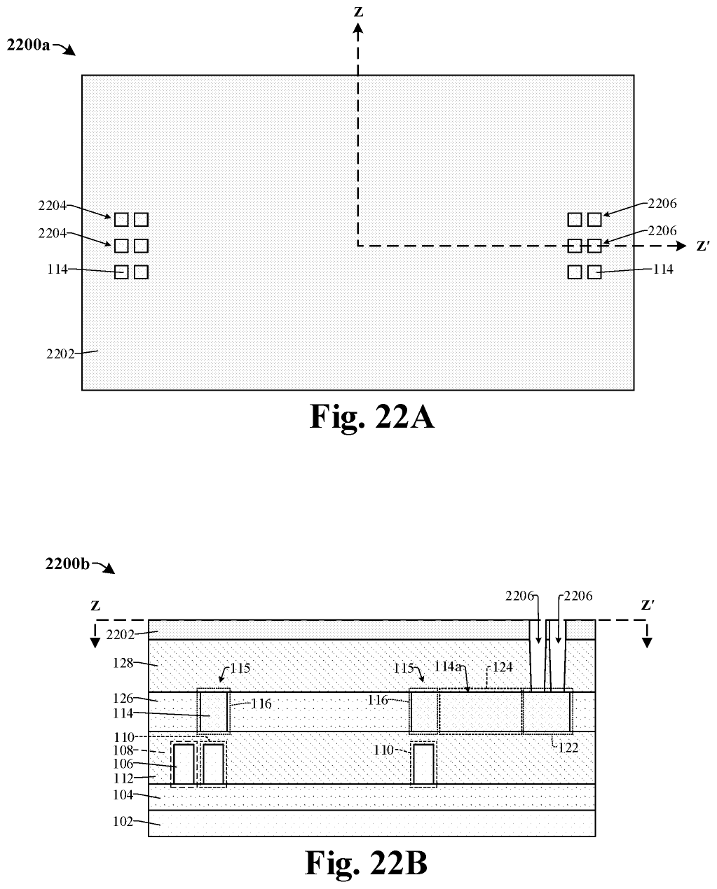

As shown in top view 2200a of FIG. 22A and corresponding cross-sectional view 2000b of FIG. 22B, the second upper dielectric layer 128 is etched to form contact openings 2204, 2206 in the second upper dielectric layer 128 and over the heater contact pads 118, 122, respectively. In some embodiments, the contact openings 2204, 2206 uncover a top surface 114a of the conductive heater layer 114 at the heater contact pads 118, 122, respectively. In some embodiments, the etching is performed according to a masking layer 2202. In some embodiments, the masking layer 2202 comprises a photoresist mask layer, a hard mask layer, or some other suitable masking layer. In some embodiments, the etching comprises a dry etching process or some other suitable process.

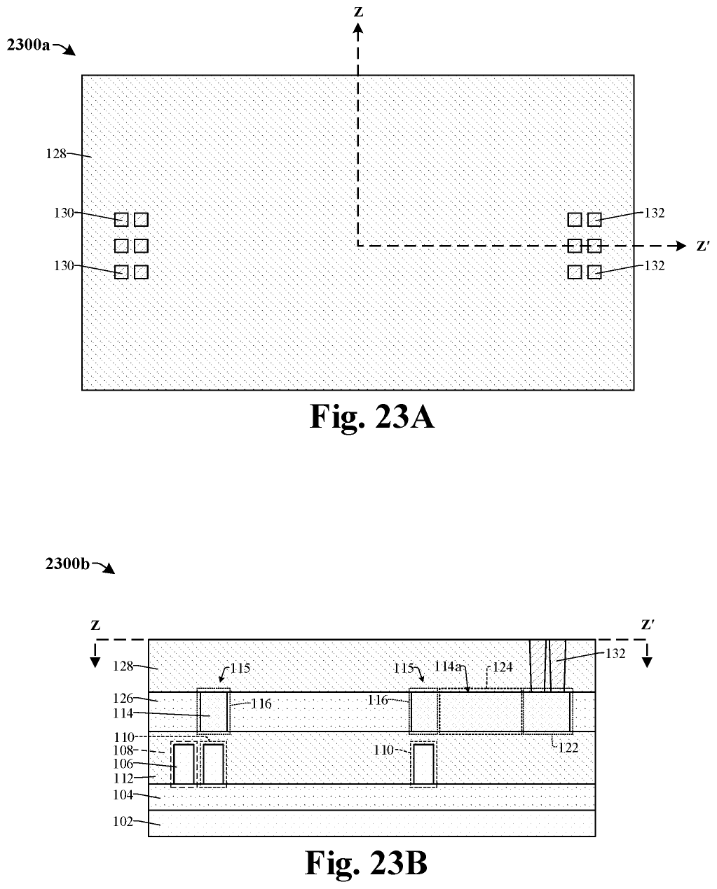

As shown in top view 2300a of FIG. 23A and corresponding cross-sectional view 2300b of FIG. 23B, a metal is deposited over the second upper dielectric layer 128 and in the contact openings 2204, 2206 to form contacts 130, 132 respectively in the contact openings 2204, 2206. In some embodiments, the metal comprises tungsten or some other suitable material. In some embodiments, the metal is deposited by a CVD process, a PVD process, or some other suitable process. In some embodiments, a planarization process (e.g., a CMP or some other suitable process) is performed on the metal after the metal is deposited to further form (e.g., further delimit) the contacts 130, 132.

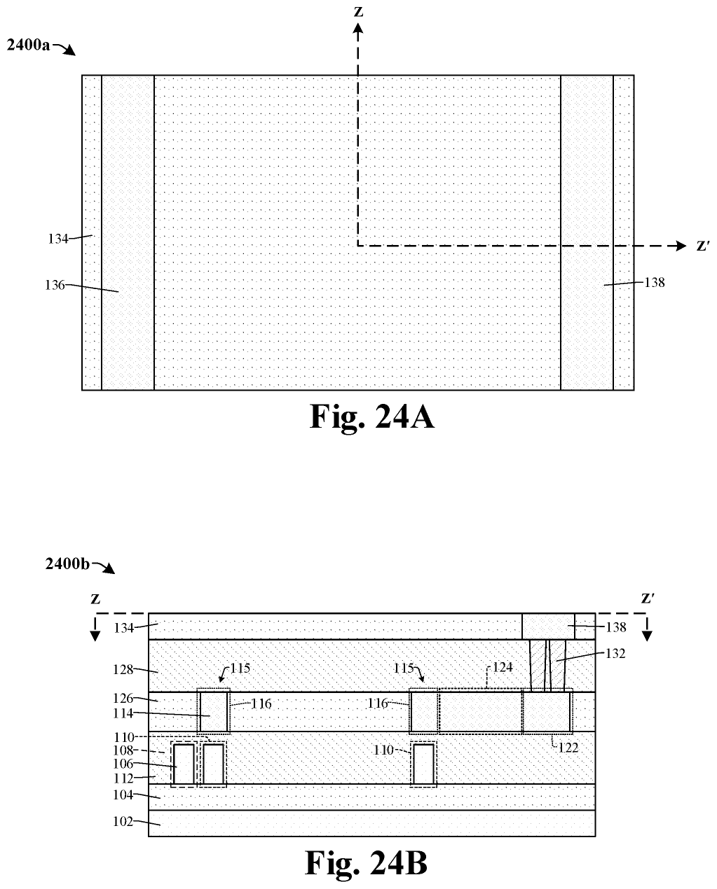

As shown in top view 2400a of FIG. 24A and corresponding cross-sectional view 2400b of FIG. 24B, a third upper dielectric layer 134 is deposited over the second upper dielectric layer 128. Further, metal lines 136, 138 are formed within the third upper dielectric layer 134 and directly over the contacts 130, 132, respectively. In some embodiments, the metal lines 136, 138 are formed by etching the third upper dielectric layer 134, depositing metal over the third upper dielectric layer 134 after the etching, and performing a planarization process on the metal. In some embodiments, the metal comprises copper, aluminum, or some other suitable material.

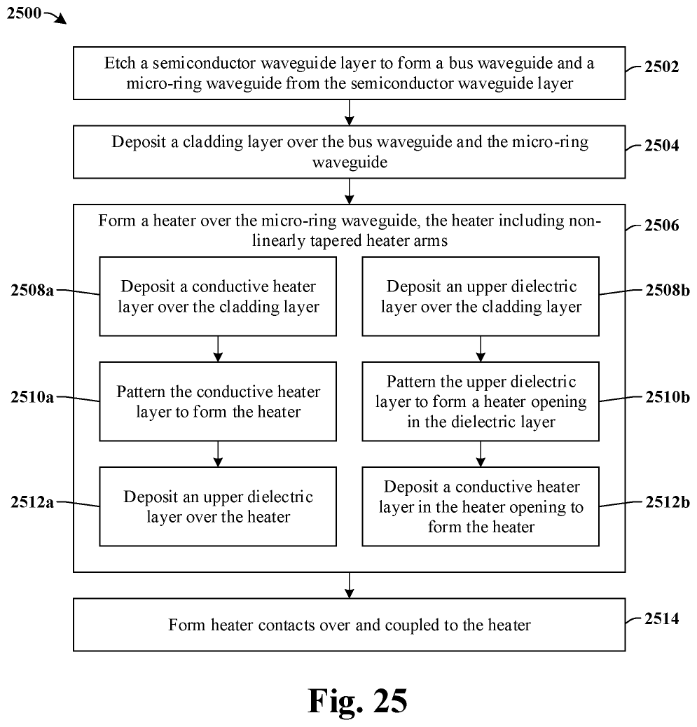

FIG. 25 illustrates a flow diagram of some embodiments of a method 2500 for forming an integrated chip comprising a heater over a micro-ring waveguide. While method 2500 is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

At block 2502, etch a semiconductor waveguide layer to form a bus waveguide and a micro-ring waveguide from the semiconductor waveguide layer. FIG. 13A illustrates a top view 1300a and FIG. 13B illustrates a corresponding cross-sectional view 1300b of some embodiments corresponding to block 2502.

At block 2504, deposit a cladding layer over the bus waveguide and the micro-ring waveguide. FIG. 14A illustrates a top view 1400a and FIG. 14B illustrates a corresponding cross-sectional view 1400b of some embodiments corresponding to block 2502.

At block 2506, form a heater over the micro-ring waveguide, the heater including non-linearly tapered heater arms.

In some embodiments, block 2506 includes blocks 2508a, 2510a, 2512a.

At block 2508a, deposit a conductive heater layer over the cladding layer. FIG. 15A illustrates a top view 1500a and FIG. 15B illustrates a corresponding cross-sectional view 1500b of some embodiments corresponding to block 2508a.

At block 2510a, pattern the conductive heater layer to form the heater. FIG. 16A illustrates a top view 1600a and FIG. 16B illustrates a corresponding cross-sectional view 1600b of some embodiments corresponding to block 2510a.

At block 2512a, deposit an upper dielectric layer over the heater. FIG. 17A illustrates a top view 1700a and FIG. 17B illustrates a corresponding cross-sectional view 1700b of some embodiments corresponding to block 2512a.

In some other embodiments, block 2506 includes blocks 2508b, 2510b, 2512b.

At block 2508b, deposit an upper dielectric layer over the cladding layer. FIG. 18A illustrates a top view 1800a and FIG. 18B illustrates a corresponding cross-sectional view 1800b of some embodiments corresponding to block 2508b.

At block 2510b, pattern the upper dielectric layer to form a heater opening in the dielectric layer. FIG. 19A illustrates a top view 1900a and FIG. 19B illustrates a corresponding cross-sectional view 1900b of some embodiments corresponding to block 2510b.

At block 2512b, deposit a conductive heater layer in the heater opening to form the heater. FIG. 20A illustrates a top view 2000a and FIG. 20B illustrates a corresponding cross-sectional view 2000b of some embodiments corresponding to block 2512b.

At block 2514, form heater contacts over and coupled to the heater. FIG. 23A illustrates a top view 2300a and FIG. 23B illustrates a corresponding cross-sectional view 2300b of some embodiments corresponding to block 2514.

Thus, the present disclosure relates to an integrated chip and a method for forming the integrated chip, the integrated chip including a heater over a micro-ring waveguide, the heater including non-linearly tapered heater arms for improving a performance and efficiency of the heater.

Accordingly, in some embodiments, the present disclosure relates to an integrated chip including a semiconductor waveguide layer over a base dielectric layer. The semiconductor waveguide layer forms a bus waveguide and a micro-ring waveguide alongside the bus waveguide. A heater is over the micro-ring waveguide. The heater includes a heater ring, a first heater contact pad, a first heater arm extending from the heater ring to the first heater contact pad, a second heater contact pad, and a second heater arm extending from the heater ring to the second heater contact pad. A first contact is coupled to the heater at the first heater contact pad. A second contact is coupled to the heater at the second heater contact pad. A width of the first heater arm increases non-linearly as a distance from the heater ring increases.

In other embodiments, the present disclosure relates to an integrated chip including a substrate, a base dielectric layer over the substrate, and a semiconductor waveguide layer over the base dielectric layer. The semiconductor waveguide layer forms a bus waveguide and a micro-ring waveguide alongside the bus waveguide. A cladding layer is over the bus waveguide and the micro-ring waveguide. A conductive heater layer is over the cladding layer and the micro-ring waveguide. The conductive heater layer forms a heater ring, a first heater contact pad, a first heater arm extending from the heater ring to the first heater contact pad, a second heater contact pad, and a second heater arm extending from the heater ring to the second heater contact pad. The first heater arm is formed by a pair of first sidewalls and a pair of second sidewalls of the conductive heater layer. A plurality of first contacts are over and coupled to the conductive heater layer at the first heater contact pad. A plurality of second contacts are over and coupled to the conductive heater layer at the second heater contact pad. The pair of first sidewalls extend along non-linear paths from the heater ring to the pair of second sidewalls, respectively. A distance between the pair of first sidewalls is equal to a first value at a first location where the first heater arm joins the heater ring. The distance between the pair of first sidewalls is equal to a second value, greater than the first value, at a second location where the pair of first sidewalls respectively meet the pair of second sidewalls. The distance between the pair of first sidewalls increases non-linearly from the first value at the first location to the second value at the second location.

In yet other embodiments, the present disclosure relates to a method for forming an integrated chip. The method includes etching a semiconductor waveguide layer to form a bus waveguide and a micro-ring waveguide from the semiconductor waveguide layer. A cladding layer is deposited over the bus waveguide and the micro-ring waveguide. A heater is formed over the micro-ring waveguide. The heater includes a heater ring, a first heater contact pad, a first heater arm extending from the heater ring to the first heater contact pad, a second heater contact pad, and a second heater arm extending from the heater ring to the second heater contact pad. The first heater arm has a first width at a first location where the first heater arm joins the heater ring. The first heater arm has a second width, greater than the first width, at a second location located between the heater ring and the first heater contact pad. The width of the first heater arm increases non-linearly from the first width at the first location to the second width at the second location. A first contact and a second contact are formed over the heater. The first contact is coupled to the heater at the first heater contact pad. The second contact is coupled to the heater at the second heater contact pad.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated chip, comprising:
a semiconductor waveguide layer over a base dielectric layer, the semiconductor waveguide layer forming a bus waveguide and a micro-ring waveguide alongside the bus waveguide;
a heater over the micro-ring waveguide, the heater including a heater ring, a first heater contact pad, a first heater arm extending from the heater ring to the first heater contact pad, a second heater contact pad, and a second heater arm extending from the heater ring to the second heater contact pad;
a first contact coupled to the heater at the first heater contact pad; and
a second contact coupled to the heater at the second heater contact pad;
wherein a width of the first heater arm increases non-linearly as a distance from the heater ring increases.

2. The integrated chip of claim 1, wherein a difference between an outer radius of the heater ring and an inner radius of the heater ring is equal to a first value, wherein the width of the first heater arm is equal to a second value at a first location where the first heater arm joins the heater ring, and wherein a difference between the second value and the first value is less than 10%.

3. The integrated chip of claim 2, wherein the width of the first heater arm increases non-linearly from the second value at the first location to a third value at a second location laterally spaced from the first location and the heater ring, and wherein the third value is greater than the second value by at least 40%.

4. The integrated chip of claim 1, wherein the width of the first heater arm increases non-linearly at a rate which increases as the distance from the heater ring increases.

5. The integrated chip of claim 1, wherein the width of the first heater arm increases non-linearly from a first location where the first heater arm joins the heater ring to a second location laterally spaced from the first location and the heater ring, and wherein the width of the first heater arm is approximately constant from the second location to a third location where the first heater arm joins the first heater contact pad.

6. The integrated chip of claim 1, wherein the width of the first heater arm increases non-linearly from a first location where the first heater arm joins the heater ring to a second location laterally spaced from the first location and the heater ring, and wherein the width of the first heater arm increases linearly from the second location to a third location where the first heater arm joins the first heater contact pad.

7. The integrated chip of claim 1, wherein a width of the first heater contact pad is greater than a maximum width of the first heater arm.

8. The integrated chip of claim 1, wherein the heater includes a third heater contact pad, a third heater arm extending from the heater ring to the third heater contact pad, a fourth heater contact pad, and a fourth heater arm extending from the heater ring to the fourth heater contact pad.

9. The integrated chip of claim 8, wherein the heater includes a fifth heater contact pad, a fifth heater arm extending from the heater ring to the fifth heater contact pad, a sixth heater contact pad, a sixth heater arm extending from the heater ring to the sixth heater contact pad, a seventh heater contact pad, a seventh heater arm extending from the heater ring to the seventh heater contact pad, an eighth heater contact pad, and an eighth heater arm extending from the heater ring to the eighth heater contact pad.

10. An integrated chip, comprising:
a substrate;
a base dielectric layer over the substrate;
a semiconductor waveguide layer over the base dielectric layer, the semiconductor waveguide layer forming a bus waveguide and a micro-ring waveguide alongside the bus waveguide;
a cladding layer over the bus waveguide and the micro-ring waveguide;
a conductive heater layer over the cladding layer and the micro-ring waveguide, the conductive heater layer forming a heater ring, a first heater contact pad, a first heater arm extending from the heater ring to the first heater contact pad, a second heater contact pad, and a second heater arm extending from the heater ring to the second heater contact pad, wherein the first heater arm is formed by a pair of first sidewalls and a pair of second sidewalls of the conductive heater layer;
a plurality of first contacts over and coupled to the conductive heater layer at the first heater contact pad; and
a plurality of second contacts over and coupled to the conductive heater layer at the second heater contact pad;
wherein the pair of first sidewalls extend along non-linear paths from the heater ring to the pair of second sidewalls, respectively, wherein a distance between the pair of first sidewalls is equal to a first value at a first location where the first heater arm joins the heater ring, wherein the distance between the pair of first sidewalls is equal to a second value, greater than the first value, at a second location where the pair of first sidewalls respectively meet the pair of second sidewalls, and wherein the distance between the pair of first sidewalls increases non-linearly from the first value at the first location to the second value at the second location.

11. The integrated chip of claim 10, wherein the heater ring is formed by an inner ring sidewall and an outer ring sidewall of the conductive heater layer, wherein a distance between the inner ring sidewall and the outer ring sidewall is equal to a third value, wherein a difference between the first value and the third value is less than 10%, and wherein the second value is at least 40% greater than the first value.

12. The integrated chip of claim 10, wherein a distance between the pair of second sidewalls is equal to the second value at the second location, wherein the distance between the pair of second sidewalls is equal to a third value, greater than the second value, at a third location where the first heater arm joins the first heater contact pad, and wherein the distance between the pair of second sidewalls increases linearly from the second value at the second location to the third value at the third location.

13. The integrated chip of claim 10, wherein a distance between the pair of second sidewalls is equal to the second value at the second location, wherein the distance between the pair of second sidewalls is equal to a third value at a third location where the first heater arm joins the first heater contact pad, and wherein the third value is approximately equal to the second value.

14. The integrated chip of claim 10, wherein contact pad is formed by a pair of third sidewalls of the conductive heater layer, wherein a distance between the pair of third sidewalls is greater than a maximum distance between the pair of second sidewalls.

15. The integrated chip of claim 10, wherein a rate of change of the distance between the pair of first sidewalls increases from a first rate at the first location to a second rate, greater than the first rate, at the second location.

16. The integrated chip of claim 10, wherein the heater ring has a rectangular ring shape.

17. A method for forming an integrated chip, the method comprising:
etching a semiconductor waveguide layer to form a bus waveguide and a micro-ring waveguide from the semiconductor waveguide layer;
depositing a cladding layer over the bus waveguide and the micro-ring waveguide;
forming a heater over the micro-ring waveguide, the heater including a heater ring, a first heater contact pad, a first heater arm extending from the heater ring to the first heater contact pad, a second heater contact pad, and a second heater arm extending from the heater ring to the second heater contact pad, wherein the first heater arm has a first width at a first location where the first heater arm joins the heater ring, wherein the first heater arm has a second width, greater than the first width, at a second location located between the heater ring and the first heater contact pad, and wherein the width of the first heater arm increases non-linearly from the first width at the first location to the second width at the second location; and
forming a first contact and a second contact over the heater, the first contact coupled to the heater at the first heater contact pad, the second contact coupled to the heater at the second heater contact pad.

18. The method of claim 17, wherein the forming the heater over the micro-ring waveguide comprises:
depositing a conductive heater layer over the cladding layer;
etching the conductive heater layer to form the heater including the heater ring, the first heater contact pad, the first heater arm, the second heater contact pad, and the second heater arm; and
depositing an upper dielectric layer over the heater.

19. The method of claim 17, wherein the forming the heater over the micro-ring waveguide comprises:
depositing an upper dielectric layer over the cladding layer;
etching the upper dielectric layer to form a heater opening including a heater ring region, a first heater contact pad region, a first heater arm region, a second heater contact pad region, and a second heater arm region; and
depositing a conductive heater layer in the heater opening to form the heater including the heater ring, the first heater contact pad, the first heater arm, the second heater contact pad, and the second heater arm.

20. The method of claim 17, wherein the heater includes a third heater contact pad, a third heater arm extending from the heater ring to the third heater contact pad, a fourth heater contact pad, and a fourth heater arm extending form the heater ring to the fourth heater contact pad.
